(19) United States
(12) Patent Application Publication
(10) Pub. No.: US 2023/0340826 A1
(43) Pub. Date: Oct. 26, 2023

(54) DOOR MONITORING SYSTEM AND METHOD

(71) Applicant: Gentex Corporation, Zeeland, MI (US)

(72) Inventors: Matthew W. Remijn, Grand Rapids, MI (US); Ingo R. Schwetz, Flein (DE)

(73) Assignee: Gentex Corporation, Zeeland, MI (US)

(21) Appl. No.: 18/136,399

(22) Filed: Apr. 19, 2023

Related U.S. Application Data
(60) Provisional application No. 63/334,847, filed on Apr. 26, 2022.

(51) Int. Cl. E05F 15/40; E05F 15/76; B60Q 9/00

(52) U.S. Cl. CPC E05F 15/40; E05F 15/76; B60Q 9/008; E05F 2015/765

(57) ABSTRACT

A monitoring system is configured to prevent a door of a vehicle from contacting an object in a travel path of the door. The monitoring system includes an alarm device and a structured light assembly that has at least one optical projector and at least one image capturing module configured to detect an object in the travel path of the door. A control system is configured to generate a notification, with the alarm device, upon the detected presence of the object in the travel path of the door.

### CROSS-REFERENCE TO RELATED APPLICATION

This application claims priority to and the benefit under 35 U.S.C. § 119(e) of U.S. Provisional Application No. 63/334,847, filed on Apr. 26, 2022, entitled “DOOR MONITORING SYSTEM AND METHOD,” the disclosure of which is hereby incorporated herein by reference in its entirety.

### FIELD OF THE DISCLOSURE

The present disclosure generally relates to a door monitoring system and method, and more particularly to utilizing a structured light to prevent moving a door into contact with an object.

### SUMMARY OF THE DISCLOSURE

According to one aspect of the present disclosure, a monitoring system is configured to prevent a door of a vehicle from contacting an object in a travel path of the door. The monitoring system includes an alarm device and a structured light assembly that has at least one optical projector and at least one image capturing module configured to detect an object in the travel path of the door. A control system is configured to generate a notification, with the alarm device, upon a detected presence of the object in the travel path of the door.

According to another aspect of the disclosure, a monitoring system is configured to prevent a door of a vehicle from contacting an object in a travel path of the door. The monitoring system includes a vision system that has at least one image capturing module configured to detect an object in the travel path of the door. The monitoring system further includes a locking device and an alarm device. A control system is configured to generate a first notification, with the alarm device, upon a detected presence of the object in the travel path of the door after actuation of a latch of the door. The control system is further configured to generate a second notification that is different than the first notification, with the alarm device, once the door is moved in a position that is a predetermined distance for the object. The control system is further still configured to actuate the locking device when the door reaches a threshold distance from the object to prevent further travel of the door, the threshold distance being closer than the predetermined distance.

According to yet another aspect of the disclosure, a vehicle includes a door and a structural pillar located adjacent to the door defining an aperture. A monitoring system is configured to prevent the door from contacting an object in a travel path of the door. The monitoring system includes a vision system having an image capturing module that is located within the structural pillar and aligned with the aperture that is configured to detect an object in the travel path of the door and an alarm device. A control system is configured to generate a first notification, with the alarm device, upon a detected presence of the object in the travel path of the door.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1A is a perspective view of an automobile that incorporates a door monitoring system according to an aspect of the present disclosure;

FIG. 1B is a perspective view of an automobile that incorporates the door monitoring system according to an aspect of the present disclosure;

FIG. 1C is a sectional view of an automobile that incorporates the door monitoring system according to an aspect of the present disclosure;

FIG. 2 schematically illustrates the door monitoring system according to an aspect of the present disclosure;

FIG. 3 schematically illustrates the door monitoring system with a door in a series of positions according to an aspect of the present disclosure;

FIG. 4 schematically illustrates a control system of the door monitoring system according to the present disclosure; and

FIG. 5 is a method of preventing a door of a vehicle from contacting an object in a travel path of the door according to the present disclosure.

### DETAILED DESCRIPTION

The present illustrated embodiments reside primarily in combinations of method steps and apparatus components related to a door monitoring system. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

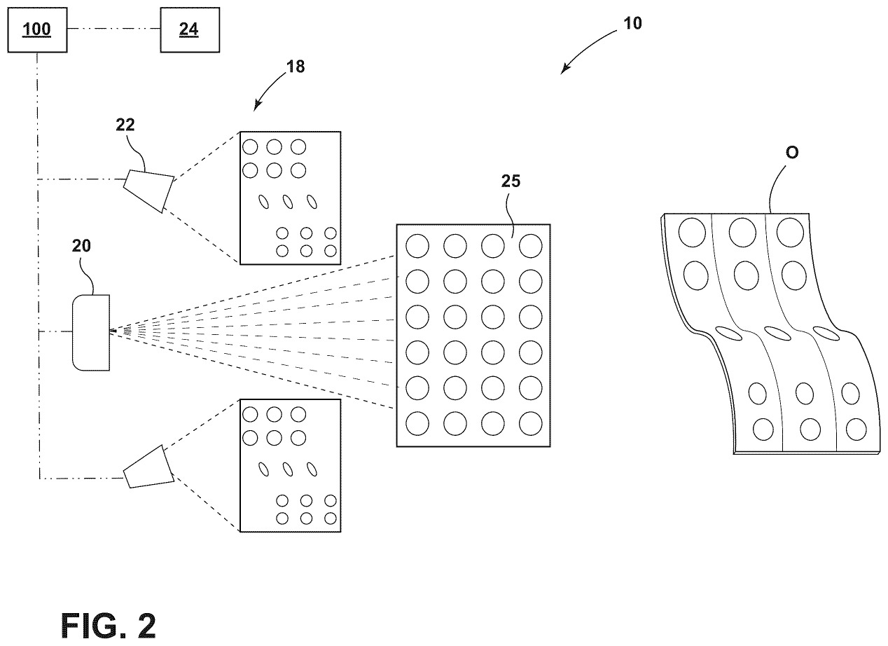

For purposes of description herein, the terms “upper,” “lower,” “right,” “left,” “rear,” “front,” “vertical,” “horizontal,” and derivatives thereof, shall relate to the disclosure as oriented in FIG. 2. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

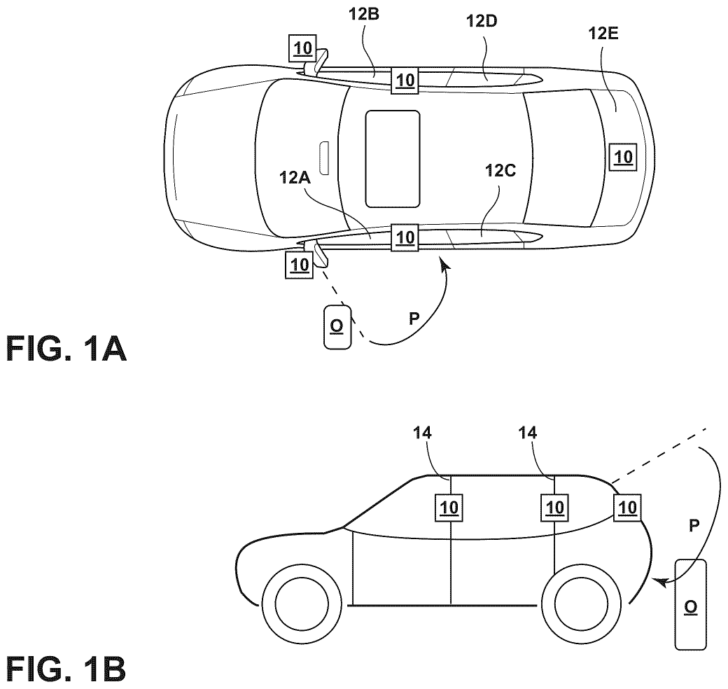

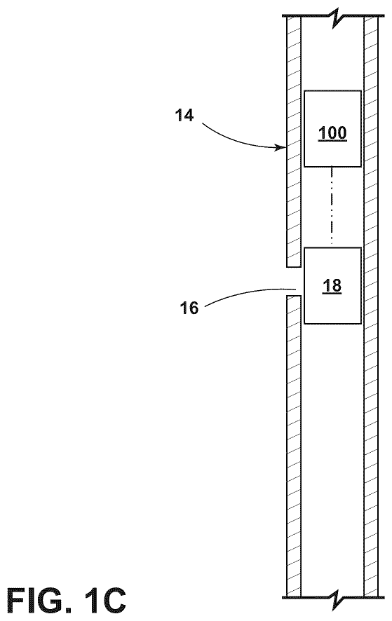

Referring to FIGS. 1A-1C, reference numeral 10 generally designates a door monitoring system (i.e. “monitoring system”). The monitoring system 10 is configured to monitor for objects within a travel path “P” of a door 12 to prevent the door 12 from coming into contact with an object “O”. More particularly, doors 12 can be articulated along the travel path P between a closed position, a fully opened position, and intermediate positions. Various embodiments of monitoring system 10 may be incorporated with doors 12A-12E of one or more structures. For example, FIG. 1A illustrates an automobile employing the monitoring system 10. The monitoring system 10 may include a plurality of monitoring systems 10 located at or adjacent to one or more front doors 12A, 12B, one or more rear doors 12C, 12D, a trunk door 12E, and/or the like. It should be appreciated that one monitoring system 10 may monitor more than one door 12, for example, a first monitoring system 10 may monitor doors 12A and 12C and a second monitoring system 10 may monitor doors 12B and 12D. The automobile may include a commercial vehicle, an emergency vehicle, a residential vehicle, an airplane, or the like. FIG. 1B illustrates a side view of the example vehicle. The monitoring system 10 may be located in or on an exterior rearview mirror, on a top surface of the vehicle body, a hood, a side surface of the vehicle body, one of the doors 12A-12E, and/or the like. As best illustrated in FIG. 1C, components of the monitoring system 10 may be located on an exterior or interior surface of a pillar 14, for example, a B-pillar. In some embodiments, the pillar 14 may include an aperture 16 for allowing components of the monitoring system 10 to transmit and receive therethrough. As will be described in greater detail below, the monitoring system 10 may include a control system 100 to, at least, perform the functions and methods described herein. The control system 100 may be localized adjacent to monitoring system 10, for example, on an exterior or interior surface of the pillar 14. The control system 100 may also be located in other locations of the vehicle. In some embodiments, each or select monitoring systems 10 located in a vehicle may have a corresponding control system 100 such that more than one control system 100 is present. In other embodiments, each monitoring system 10 is controlled by a single control system 100. Generally speaking, the monitoring system 10 may be incorporated into any environment wherein a door position can be beneficially monitored.

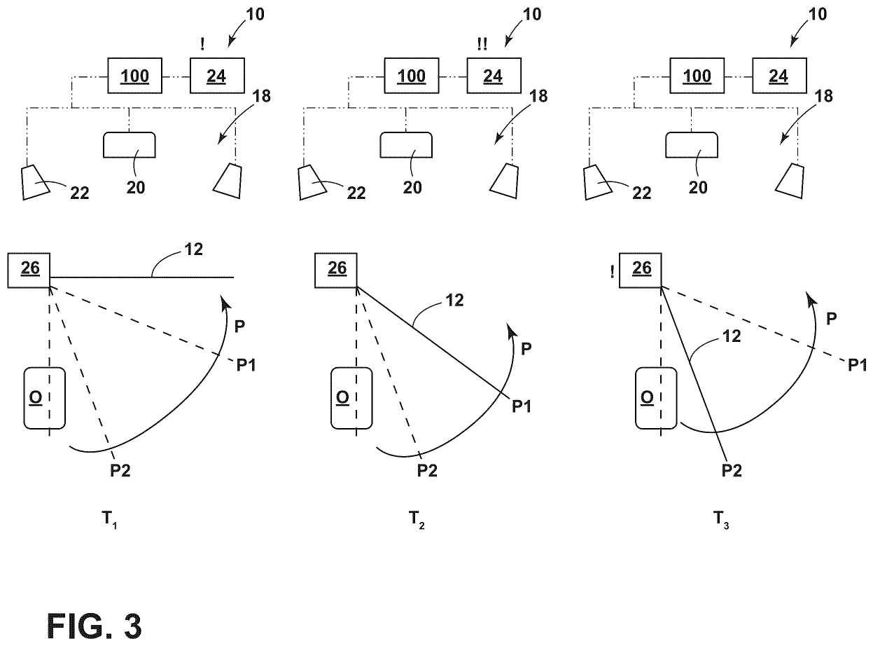

With reference now to FIGS. 2 and 3, the monitoring system 10 may include a vision system, such as a structured light assembly 18. The structured light assembly 18 includes at least one optical projector 20 and at least one image capturing module 22. The monitoring system 10 may further include an alarm device 24, for example, a display device located in an interior rearview mirror (e.g. a full display rearview mirror), other interior vehicle locations, monitors, portable electronic devices, audio systems in the vehicle, localized audio devices, haptic feedback devices, and/or the like. For example, the present disclosure may be used with a display mirror system such as that described in U.S. Pat. Nos. 9,505,349 and 10,739,591, which are hereby incorporated herein by reference in their entirety. It should be appreciated that, in other embodiments, the monitoring system 10 may include other vision systems, such as radar, LIDAR, depth sensing, vision sensing, stereovision, other three dimensional vision systems, two dimensional vision systems, and/or the like.

In operation, the optical projector 20 is configured to display a structured optical pattern 25 on an object O. The optical pattern 25 may include an array of shapes (e.g. circles), a series of alternating stripes of light, and/or the like. When the optical pattern 25 is projected on the object O, the array of shapes conform to the surface of the object O and may be distorted. The at least one image capturing module 22 may include cameras that capture the size, relative spacing, and/or distortions of the optical pattern 25 (e.g. the shape, size, and spacing of the array of shapes, lines, etc.) that can therefore be used, in conjunction with the control system 100, to determine a presence of the object O and characteristics of the object O (e.g. shape, position, depth, location, etc.). In some embodiments, the optical projector 20 may be configured to project the optical pattern 25 in a visible wavelength to the human eye. In some embodiments, the visible optical pattern 25 may only be projected along the path P and/or an area confined between the path P and a door frame. In some embodiments, the optical pattern 25 may be non-visible to the human eye. In some embodiments, the optical pattern 25 may be non-visible until an object O is detected in the travel path P and the vehicle is in park and/or a door latch is actuated.

As best illustrated in FIG. 3, the presence and location of the object O can be determined, such that it can be recognized when the object O is within the travel path P of the door 12. In some embodiments, the travel path P can be modeled or profiled such that the travel path P is known and pre-saved without input from the monitoring system 10. In other embodiments, as the door 12 is moved along the travel path P from the closed position (left) to an open position (right), the optical pattern 25 becomes distorted and the control system 100 can precisely measure the door's 12 location along the travel path P and predict a location of the door 12 upon further movement along the travel path P. The object O may intersect the travel path P of the door 12 based on relative movement between the object O and the door 12 (e.g. by moving a vehicle in close proximity to the object O or by the object O moving in close proximity to the vehicle).

When an object O is detected within the travel path P, certain steps and methods may be implemented to prevent the door 12 from opening into and contacting the object O. Starting with the leftmost drawing in FIG. 3 at time T1 and moving right to subsequent times T2 and T3, the monitoring system 10 detects the presence of an object O within the travel path P of a door 12. Based on this detection, the alarm device 24 may notify, for example, by generating a first notification “V” to an operator of the door 12 (e.g. a vehicle occupant) of the presence of the object O via an audible warning (e.g. a beeping and/or the like), a graphical display (e.g. a visual warning), and/or a haptic feedback (e.g. a vibration). In some embodiments, this notification may include displaying which doors 12A-12E have an object O within their respective travel paths P, include an audible warning, and/or a haptic feedback notification. The haptic feedback notification may include vibrating the door 12A-12E, a seat in the vehicle, or a steering wheel. The control system 100 may only facilitate the notification upon certain factors, for example, if the vehicle is in park, if the latch for the door 12 is actuated, and/or the like. After the door 12 is opened and travels along the travel path P to a first position P1, the alarm device 24 may notify, for example, by generating a second notification “!!” to a vehicle occupant of the presence of the object O via an audible warning and/or graphical display. The first position P1 may be associated with a first distance from the object. In some embodiments, the second notification !! is different than the first notification !, for example, the second notification !! may be louder and/or have a higher frequency. In some embodiments, the alarm device 24 progressively gets louder and/or progressively has a higher frequency as the door 12 approaches the object O.

The monitoring system 10 may include a locking device 26 to prevent the door 12 from further opening and/or closing along the travel path P. After the door 12 is opened and travels along the travel path P to a second position P2, the locking device 26 may prevent the door 12 from further travel, for example, by locking further progression of the door 12 along the travel path P. The second position P2 may be associated with a second distance from the object O that is closer than the first distance associated with the first position P1. The locking device 26 may include a linear motor unit, a locking pawl, a lock pin, a rack and pinion unit, and/or any other locking mechanisms. The control system 100 controls the actuation of the locking device 26. In some embodiments, the control system 100 may be associated with a user interface that allows a user to override certain functionalities of the monitoring system 10. In some embodiments, the control system 100 may be configured to de-actuate the locking device 26 after a predetermined time period (e.g. 1 or more seconds) and/or after a certain amount of attempts (e.g. during a second attempt) to open or close the door 12. Thus, a user may effectively override the locking device 26 after prolonged pressure on the door 12 or after a certain amount of attempts. In some embodiments, the control system 100 may be configured to increase the pressure required to open the door 12 as the door 12 approaches the object O to slow the door 12 and reduce the kinetic energy thereof.

While FIGS. 1A-3 illustrate an object O on an outward side of the travel path P from the door 12, it should be appreciated that the monitoring system 10 may implement the same protocols for objects O detected in the travel path P of a closing door 12, such that an operator is notified and/or prevented from closing the door 12 on certain objects O, such as an occupant or other objects.

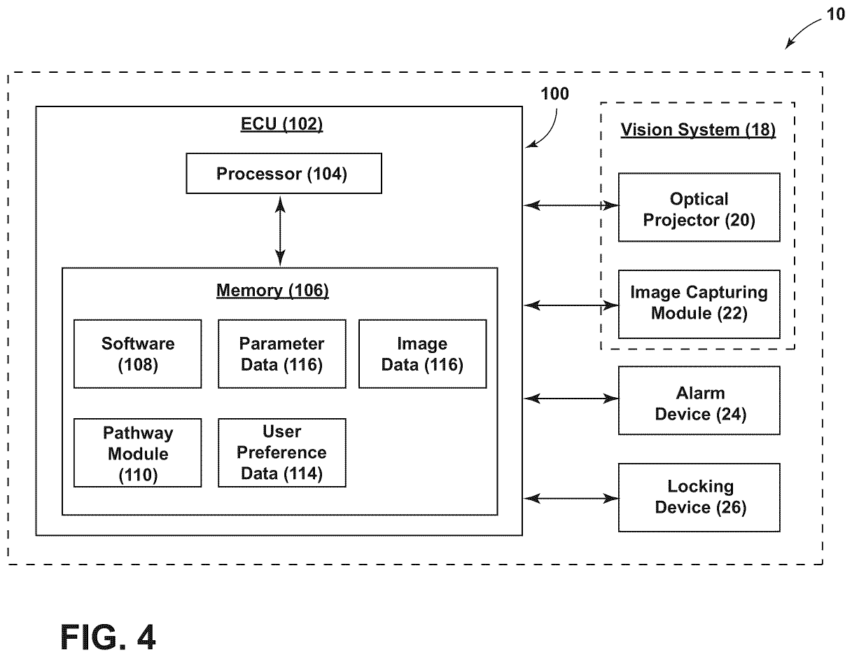

FIG. 4 schematically illustrates the control system 100 of the monitoring system 10. The control system 100 may include an electronic control unit (ECU) 102. The ECU 102 may include a processor 104 and a memory 106. The processor 104 may include any suitable processor 104. Additionally, or alternatively, the ECU 102 may include any suitable number of processors, in addition to or other than the processor 104. The memory 106 may comprise a single disk or a plurality of disks (e.g., hard drives), and includes a storage management module that manages one or more partitions within the memory 106. In some embodiments, memory 106 may include flash memory, semiconductor (solid state) memory, or the like. The memory 106 may include Random Access Memory (RAM), a Read-Only Memory (ROM), Electrically Erasable Programmable Read-Only Memory (EEPROM), or a combination thereof. The memory 106 may include instructions that, when executed by the processor 104, cause the processor 104 to, at least, perform the functions associated with the components of the monitoring system 10. The at least one optical projector 20, the at least one image capturing module 22, the at least one alarm device 24, and/or the at least one locking device 26 may therefore be controlled by the ECU 102. The memory 106 may therefore include software 108, pre-saved door pathway models 110, parameter data 112, user preference data 114, image data 116, and/or the like. The software 108 may be updated to incorporate additional functionalities or override the functionalities as described herein. The door pathway models 110 may include pre-saved travel paths P and/or detected travel paths P of one or more doors 12. The parameter data 112 may include the positions P1 and P2 and functionalities such as when to operate the alarm device 24 and when to actuate and/or de-actuate the locking device 26. The user preference data 114 may include user choices of the functionalities and/or order of functionalities. The image data 116 may include the size, location, shape, presence, and/or the like of the object O captured by the structured light assembly 18. Based on the presence of an object O detected by the structured light assembly 18 and saved as the image data 116, the control system 100 is configured to perform the functionalities as described herein.

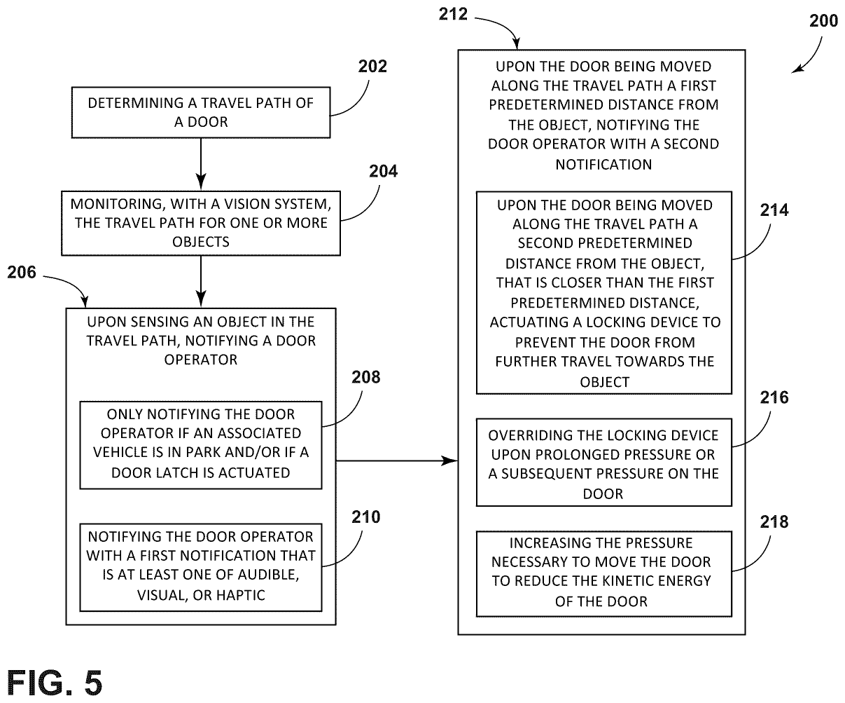

FIG. 5 illustrates a method 200 of preventing a door from contacting an object. At 202, the method 200 includes determining a travel path of the door, for example, between a closed and fully open position. At 204, the method 200 includes monitoring, with a vision system, the travel path for one or more objects. At 206, the method includes, upon sensing an object in the travel path, notifying a door operator. Step 206, may include, at 208, only notifying the door operator if an associated vehicle is in park and/or if a door latch is actuated. Step 206, may further include, at 210, notifying the door operator with a first notification that is at least one of audible, visual, or haptic. At 212, the method 200 may include, upon the door being moved along the travel path a first predetermined distance from the object, notifying the door operator with a second notification. For example, the second notification may be louder or of a higher frequency than the first notification. At 214, the method 200 may include upon the door being moved along the travel path a second predetermined distance from the object, that is closer than the first predetermined distance, actuating a locking device to prevent the door from traveling further towards the object. Step 214 may include, at 216, overriding the locking device upon prolonged pressure or a subsequent pressure on the door. Step 214, may further include yet, at 218, increasing the pressure necessary to move the door to reduce the kinetic energy of the door.

The invention disclosed herein is further summarized in the following paragraphs and is further characterized by combinations of any and all of the various aspects described therein.

According to one aspect of the present disclosure, a monitoring system is configured to prevent a door of a vehicle from contacting an object in a travel path of the door. The monitoring system includes an alarm device and a structured light assembly that has at least one optical projector and at least one image capturing module configured to detect an object in the travel path of the door. A control system is configured to generate a notification, with the alarm device, upon the detected presence of the object in the travel path of the door.

According to another aspect, a control system is further configured to generate at least one of an audible notification, a haptic notification, or an optical notification with the alarm device.

According to yet another aspect, a monitoring system includes a locking device and a control system is configured to actuate the locking device when a door reaches a threshold distance from an object to prevent further travel of the door.

According to still another aspect, a control system is further configured to generate a second notification, with an alarm device, once the door is moved in a position that is a predetermined distance for the object.

According to another aspect, a travel path of a door includes both opening and closing the door.

According to yet another aspect, a control system includes a memory with a saved door pathway model.

According to still another aspect, an optical projector is configured to project an optical pattern.

According to another aspect, an optical pattern is within a visible wavelength and projected along a travel path of a door.

According to another aspect of the disclosure, a monitoring system is configured to prevent a door of a vehicle from contacting an object in a travel path of the door. The monitoring system includes a vision system that has at least one image capturing module configured to detect an object in the travel path of the door. The monitoring system further includes a locking device and an alarm device. A control system is configured to generate a first notification, with the alarm device, upon a detected presence of the object in the travel path of the door after actuation of a latch of the door. The control system is further configured to generate a second notification that is different than the first notification, with the alarm device, once the door is moved in a position that is a predetermined distance for the object. The control system is further still configured to actuate the locking device when the door reaches a threshold distance from the object to prevent further travel of the door, the threshold distance being closer than the predetermined distance.

According to another aspect, a first notification is audible and includes a first volume and a second notification is audible and includes a second volume that is louder than the first volume.

According to yet another aspect, a vision system is configured to operate under a principle of at least one of structured light, LIDAR, and stereovision.

According to still another aspect, an optical projector is configured to project an optical pattern within non-visible wavelength to detect an object and the optical pattern is within a visible wavelength that is projected along a travel path of a door once an object is detected after the actuation of a latch of the door.

According to another aspect, a control system is configured to generate at least one of an audible notification, a haptic notification, or an optical notification with the alarm device in a first and a second notification.

According to yet another aspect of the disclosure, a vehicle includes a door and a structural pillar located adjacent to the door defining an aperture. A monitoring system is configured to prevent the door from contacting an object in a travel path of the door. The monitoring system includes a vision system having an image capturing module that is located within the structural pillar and aligned with the aperture that is configured to detect an object in the travel path of the door and an alarm device. A control system is configured to generate a first notification, with the alarm device, upon a detected presence of the object in the travel path of the door.

According to another aspect, a control system is configured to generate a second notification that is different than the first notification, with an alarm device, once the door is moved in a position that is a predetermined distance for an object.

According to yet another aspect, a locking device is configured to receive an instruction from the control system to selectively prevent further travel of the door.

According to still another aspect, a control system is configured to actuate a locking device when the door reaches a threshold distance from an object to prevent further travel of the door, the threshold distance being closer than a predetermined distance.

According to another aspect, a first notification is audible and includes a first volume and a second notification is audible and includes a second volume that is louder than the first volume.

According to yet another aspect, an optical projector is configured to project an optical pattern through an aperture in a structural pillar.

According to still another aspect, an optical pattern is within a non-visible wavelength to detect an object and the optical pattern is within a visible wavelength that is projected along the travel path once the object is detected.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be appreciated that embodiments of the disclosure described herein may be comprised of one or more conventional processors and unique stored program instructions that control one or more processors to implement, in conjunction with certain non-processor circuits, some, most, or all of the functions of a monitoring system 10, as described herein. The non-processor circuits may include, but are not limited to signal drivers, clock circuits, power source circuits, and/or user input devices. As such, these functions may be interpreted as steps of a method used in using or constructing a classification system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, the methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A monitoring system for preventing a door of a vehicle from contacting an object in a travel path of the door, the monitoring system comprising:
a structured light assembly including at least one optical projector and at least one image capturing module configured to detect an object in the travel path of the door;
an alarm device; and
a control system configured to generate a notification, with the alarm device, upon a detected presence of the object in the travel path of the door.

2. The monitoring system of claim 1, wherein the control system is further configured to generate at least one of an audible notification, a haptic notification, or an optical notification with the alarm device.

3. The monitoring system of claim 1, further including a locking device wherein the control system is further configured to actuate the locking device when the door reaches a threshold distance from the object to prevent further travel of the door.

4. The monitoring system of claim 1, wherein the control system is further configured to generate a second notification, with the alarm device, once the door is moved in a position that is a predetermined distance for the object.

5. The monitoring system of claim 1, wherein the travel path of the door includes both opening and closing the door.

6. The monitoring system of claim 5, wherein the control system includes a memory with a saved door pathway model.

7. The monitoring system of claim 1, wherein the at least one optical projector is configured to project an optical pattern.

8. The monitoring system of claim 7, wherein the optical pattern is within a visible wavelength and projected along the travel path.

9. A monitoring system for preventing a door of a vehicle from contacting an object in a travel path of the door, the monitoring system comprising:
a vision system including at least one image capturing module configured to detect an object in the travel path of the door;
a locking device;
an alarm device; and
a control system configured to:
generate a first notification, with the alarm device, upon a detected presence of the object in the travel path of the door after actuation of a latch of the door;
generate a second notification that is different than the first notification, with the alarm device, once the door is moved in a position that is a predetermined distance for the object; and
actuate the locking device when the door reaches a threshold distance from the object to prevent further travel of the door, the threshold distance being closer than the predetermined distance.

10. The monitoring system of claim 9, wherein the first notification is audible and includes a first volume and the second notification is audible and includes a second volume that is louder than the first volume.

11. The monitoring system of claim 9, wherein the vision system is configured to operate under the principle of at least one of structured light, LIDAR, and stereovision.

12. The monitoring system of claim 9, further including an optical projector configured to project an optical pattern within a non-visible wavelength to detect the object and the optical pattern is within a visible wavelength that is projected along the travel path once an object is detected after the actuation of the latch of the door.

13. The monitoring system of claim 9, wherein the control system is further configured to generate at least one of an audible notification, a haptic notification, or an optical notification with the alarm device in the first and second notifications.

14. A vehicle comprising:
a door;
a structural pillar located adjacent to the door defining an aperture;
a monitoring system for preventing the door of the vehicle from contacting an object in a travel path of the door, the monitoring system comprising:
a vision system including an image capturing module located within the structural pillar and aligned with the aperture configured to detect an object in the travel path of the door;
an alarm device; and
a control system configured to generate a first notification, with the alarm device, upon the detected presence of the object in the travel path of the door.

15. The vehicle of claim 14, wherein the control system is further configured to generate a second notification that is different than the first notification, with the alarm device, once the door is moved in a position that is a predetermined distance for the object.

16. The vehicle of claim 15, further including a locking device configured to receive an instruction from the control system to selectively prevent further travel of the door.

17. The vehicle of claim 16, wherein the control system is further configured to actuate the locking device when the door reaches a threshold distance from the object to prevent further travel of the door, the threshold distance being closer than the predetermined distance.

18. The monitoring system of claim 15, wherein the first notification is audible and includes a first volume and the second notification is audible and includes a second volume that is louder than the first volume.

19. The monitoring system of claim 14, further including an optical projector configured to project an optical pattern through the aperture.

20. The monitoring system of claim 19, wherein the optical pattern is within a non-visible wavelength to detect the object and the optical pattern is within a visible wavelength that is projected along the travel path once the object is detected.
